(19) United States
(12) Patent Application Publication
(10) Pub. No.: US 2024/0123559 A1
(43) Pub. Date: Apr. 18, 2024

(54) FIXATION DEVICE

(71) Applicant: Ching-Chi LIN, Taichung City (TW)

(72) Inventor: Ching-Chi LIN, Taichung City (TW)

(21) Appl. No.: 18/089,835

(22) Filed: Dec. 28, 2022

(30) Foreign Application Priority Data
Oct. 13, 2022 (TW) 111211151

(51) Int. Cl. B23Q 3/154; B23Q 3/06; B23Q 3/10

(52) U.S. Cl. CPC B23Q 3/1543; B23Q 3/06; B23Q 3/105

(57) ABSTRACT

A fixation device is adapted to be mounted with a machine tool and mounted to a machine bed. The fixation device includes a fixed seat, a magnetic unit, and at least one ejection unit. The fixed seat has a bottom surface and a plurality of grooves formed in the bottom surface. The magnetic unit includes a plurality of magnet blocks fixed respectively in the grooves and adapted to be magnetically positioned on the machine bed. The at least one ejection unit is mounted on the fixed seat, and includes an operating member and a supporting member. The operating member is operable to move the supporting member from a first position, where a bottom end of the supporting member is flush with the bottom surface of the fixed seat, to a second position, where the bottom end of the supporting member protrudes out from the bottom surface of the fixed seat.

### CROSS-REFERENCE TO RELATED APPLICATION

This application claims priority to Taiwanese Utility Model Patent Application No. 111211151, filed on Oct. 13, 2022.

### FIELD

This disclosure relates to a machine tool installation facility, and more particularly to a fixation device for installation of a machine tool.

### BACKGROUND

A conventional material feeding machine that is disclosed in Taiwanese Utility Model Patent No. 488372 is adapted to be mounted on a machine bed, and includes a stand fastened to the machine bed by a plurality of screws, and a feeding machine main body connected to the stand.

When the material feeding machine is in use, the feeding machine main body is used to feed wood to perform a cutting operation. Since the size and the delivering direction of the wood may be changed for different operations, it is necessary to adjust the working position and the working angle of the feeding machine main body based on the wood size and the delivering direction. Although the working position and the working angle of the feeding machine main body can be adjusted by adjusting the stand, the position and angle adjustment of the feeding machine main body is limited when the stand is not detached and put in a new position on the machine bed. Since the stand is fixed to the machine bed by means of screws, it takes a lot of effort and is rather inconvenient to remove the stand and to reinstall it in the new position, thereby resulting in a troublesome and laboring effort to adjust the working position and angle of the feeding machine main body. The fact that the stand is troublesome to disassemble and move after fastening causes obstructions when it needs to switch to another operation.

### SUMMARY

Therefore, an object of the present disclosure is to provide a fixation device for machine tool installation that can be removed and setup on a machine bed easily.

According to the disclosure, the fixation device is adapted to be mounted with a machine tool and mounted to a machine bed that is made of a magnetic metal material. The fixation device includes a fixed seat, a magnetic unit, and at least one ejection unit. The fixed seat has a bottom surface and a plurality of grooves that are formed in the bottom surface. The magnetic unit includes a plurality of magnet blocks that are fixed respectively in the grooves and that are adapted to be magnetically positioned on the machine bed. The at least one ejection unit is mounted on the fixed seat, and includes an operating member and a supporting member that is located under the operating member. The operating member is operable to move the supporting member from a first position, where a bottom end of the supporting member is flush with the bottom surface of the fixed seat, to a second position, where the bottom end of the supporting member protrudes out from the bottom surface of the fixed seat.

### BRIEF DESCRIPTION OF THE DRAWINGS

Other features and effects of the present disclosure will be clearly presented in the embodying manner with reference to the drawings, of which:

FIG. 1 is a perspective view of a machine tool mounted with an embodiment of a fixation device according to the present disclosure.

FIG. 2 is an exploded perspective view of the embodiment.

FIG. 3 is a top view of the embodiment.

FIG. 4 is a sectional view taken along line IV-IV in FIG. 3.

FIG. 5 is a sectional view taken along line V-V in FIG. 3, illustrating a supporting member of the embodiment in a first position.

FIG. 6 is a sectional view taken along line VI-VI in FIG. 3, illustrating the supporting member in the first position.

FIG. 7 is a view similar to FIG. 6, but illustrating the supporting member in a second position.

### DETAILED DESCRIPTION

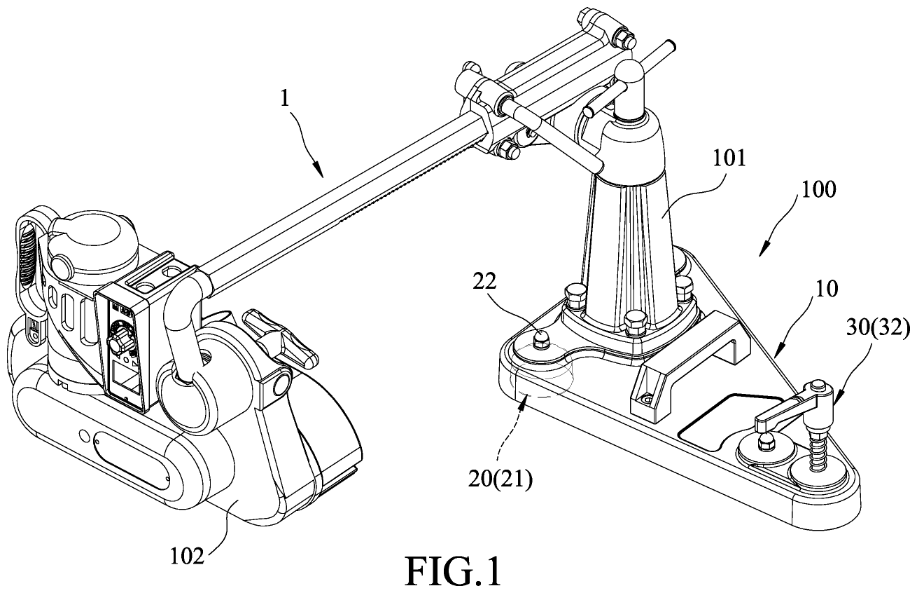

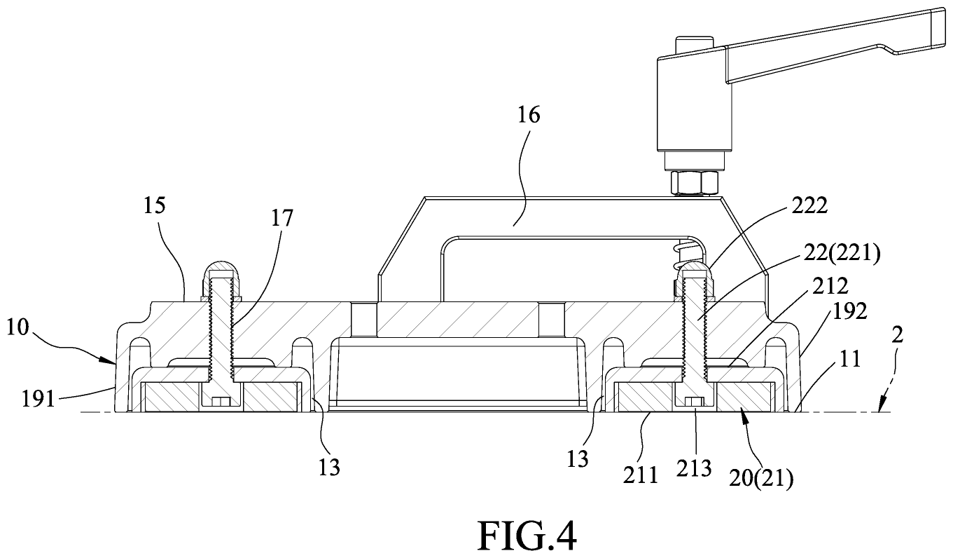

Referring to FIGS. 1 to 4, an embodiment of a fixation device 100 according to the present disclosure is adapted to be mounted with a machine tool 1 and mounted to a machine bed 2 (FIG. 4) that is made of magnetic metal material. The machine tool 1 includes a stand 101, and a main body 102 connected to the stand 101. The fixation device 100 includes a fixed seat 10, a magnetic unit 20 and an ejection unit 30. In this embodiment, the machine tool 1 is exemplified as a material feeding machine.

The fixed seat 10 has a bottom surface 11, a top surface 12 opposite to the bottom surface 11, a plurality of grooves 13 formed in the bottom surface 11, a bearing groove 14 formed in the bottom surface 11, a protrusion 15 protruding from the top surface 12, a handle 16 mounted on the top surface 12 and located to the side of the protrusion 15, a plurality of fastening holes 17 formed in the top surface 12 and extending respectively to the grooves 13, and a threaded hole 18 extending from the top surface 12 to the bearing groove 14. The fixed seat 10 is triangular, and further has three sides 191, 192, 193 and three corner portions 194, 195, 196 that are arranged alternately. Each of the corner portions 194, 195, 196 is connected between a respective adjacent pair of the sides of 191, 192, 193. Specifically, the corner portion 194 is connected between the sides 191, 193, the corner portion 195 is connected between the sides 192, 193, and the corner portion 196 is connected between the sides 191, 192. In this embodiment, the number of the grooves 13 is three, and each of the three grooves 13 is located at an inner side of a respective one of the corner portions 194, 195, 196. The bearing groove 14 is located between one of the grooves 13 and the respective one of the corner portions 196. The protrusion 15 is aligned with the other two grooves 13, and is located at an inner side of one of the sides 193 that is disposed between the other two grooves 13. The protrusion 15 is adapted to be mounted with the stand 101 of the machine tool 1.

The magnetic unit 20 includes a plurality of magnet blocks 21 respectively fixed in the grooves 13, and a plurality of fastening members 22 corresponding in position to the magnet blocks 21. Each magnet block 21 has an attraction surface 211, an upper end surface 212 that is opposite to the attraction surface 211, and a mounting hole 213 that extends from the attraction surface 211 to the top surface 212 and that is stepped. The magnet blocks 21 can be magnetically positioned on the machine bed 2 by magnetic attraction. Each fastening member 22 includes a bolt 221 extending through the mounting hole 213 of the respective magnet block 21 and the corresponding fastening hole 17, and a nut 222 fastened to a top portion of the bolt 221 via the threading and located above the top surface 12.

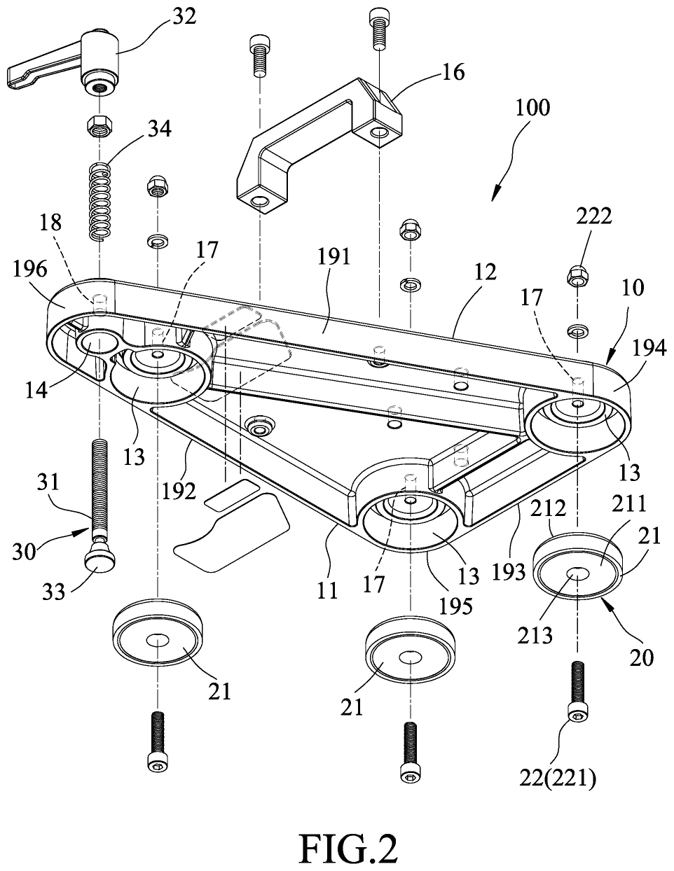

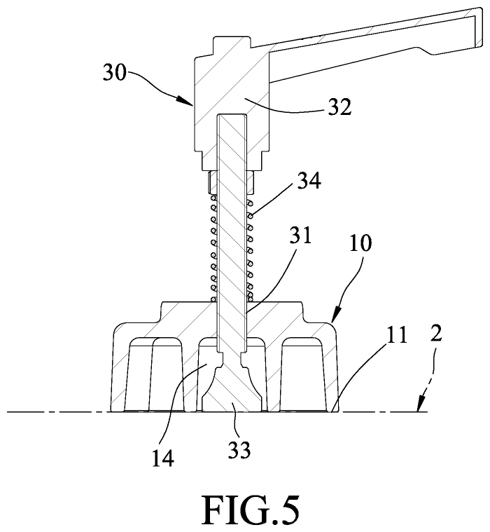

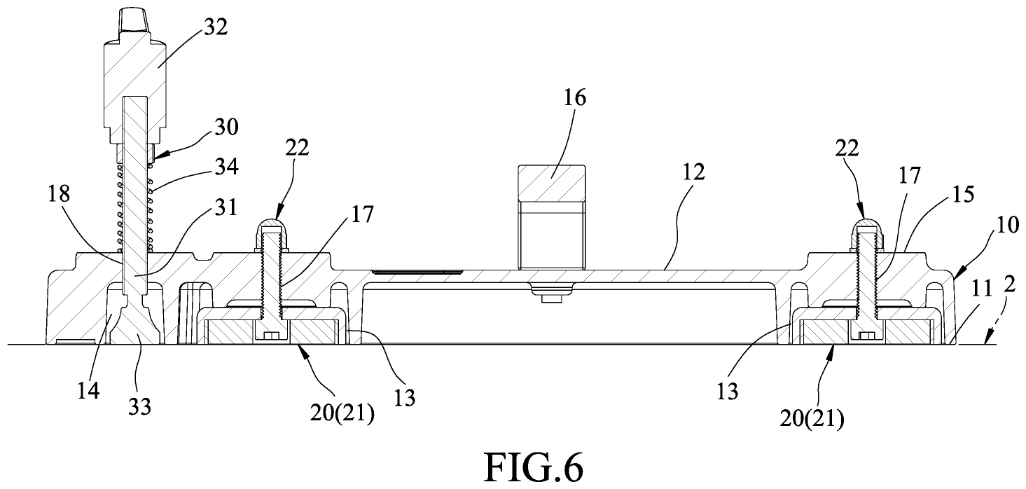

Referring to FIGS. 2, 5, and 6, the ejection unit 30 is mounted on the fixed seat 10 and is located between the one of the grooves 13 and the respective one of the corner portions 196. The ejection unit 30 includes a threaded rod 31 engaging threadedly the threaded hole 18, an operating member 32 connected to a top end of the threaded rod 31, a supporting member 33 located under the operating member 32 and connected to a bottom end of the threaded rod 31, and a spring 34 sleeved on the threaded rod 31 and having opposite ends that abut respectively against the operating member 32 and the top surface 12. The operating member 32 is connected to the top end of the threaded rod 31 via the threading. The supporting member 33 is integrally connected to the bottom end of the threaded rod 31. The spring 34 is a compression spring for biasing the operating member 32 away from the fixed seat 10.

In order to further understand the effects achieved when all elements of the present disclosure work in conjunction, the technical means applied, and the expected results that can be generated, the following explanations are presented to further facilitate deeper and more specific comprehension of the present disclosure.

In the state of FIGS. 1 and 4 to 6, when the present disclosure is fully assembled, the magnet blocks 21 are mounted respectively in the grooves 13, the attraction surfaces 211 of the magnet blocks 21 are flush with the bottom surface 11 of the fixed seat 10, the supporting member 33 is settled at a first position, where the supporting member 33 is received within the bearing groove 14 and a bottom end of the supporting member 33 is flush with the bottom surface 11. Furthermore, when the fixed seat 10 is magnetically attached to the machine bed 2 by the magnet blocks 21 of the magnetic units 20, the fixed seat 10 can be fixed stably on the machine bed 2, thereby fixing the stand 101 and the main body 102 of the machine tool 1 on the machine bed 2.

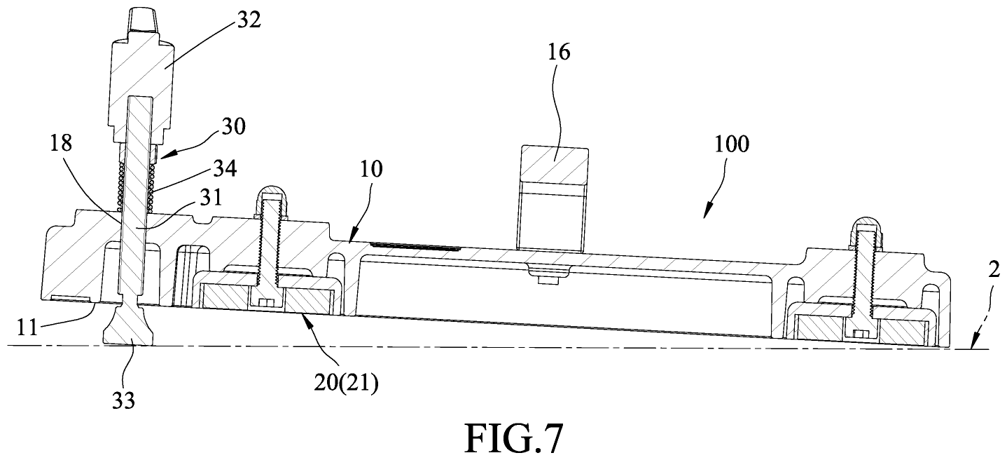

Referring to FIGS. 1, 6, and 7, when it is desired to accommodate the material size and feeding direction of wood and the adjustment of the mounting position of the fixed seat 10 is needed, the user can turn the operating member 32 of the ejection unit 30 to rotate the threaded rod 31 in situ, thereby driving the fixed seat 10 to move upward relative to the threaded rod 31 and changing the relative position between the supporting member 33 and the fixed seat 10. Specifically, the supporting member 33 is moved from the first position to a second position where the bottom end of the supporting member 33 protrudes out from the bottom surface 11 (see FIG. 7). Upon which the magnet blocks 21 are disengaged from the machine bed 2, thereby disengaging the fixed seat 10 from the machine bed 2. Then the user can grip the handle 16 to lift the fixation device 100 to the new desired mounting position that satisfies the use requirements. The abovementioned operation of the fixation device 100 is quite easy. At this time, the spring 34 is in a compressed state and stores a releasing resilient force.

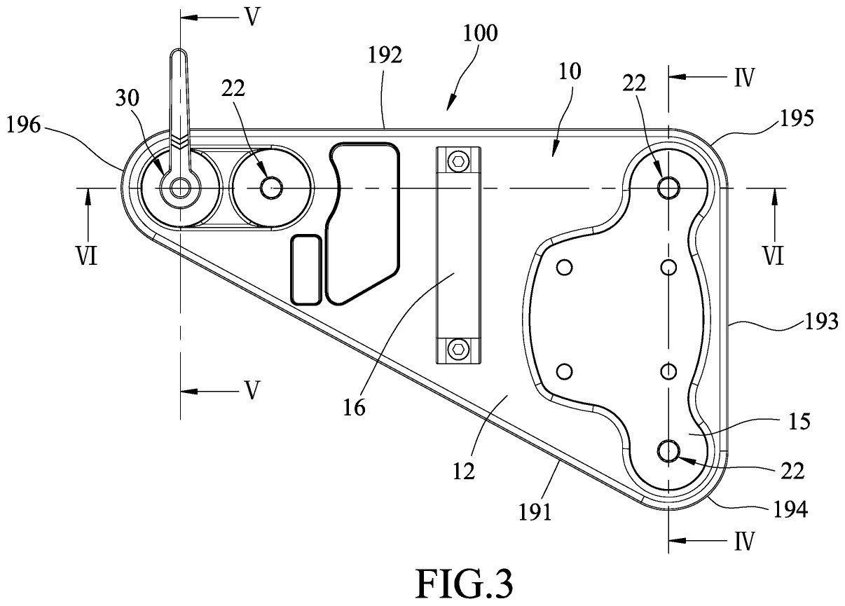

When the fixed seat 10 has been adjusted to the desired mounting position, the user turns the operating member 32 in a reverse direction to drive the threaded rod 31 to rotate in a reverse direction, thereby lowering the fixed seat 10 relative to the threaded rod 31. At this time, through the biasing force released by the spring 34, the operation is labor-saving. During the abovementioned process, the relative position between the supporting member 33 and the fixed seat 10 gradually changes, until at last the supporting member 33 settles at the first position (FIG. 3) and completely retracts into the bearing groove 14, so that the magnet blocks 21 again attract the machine bed 2, and the fixation device 100 is again fixed to the machine bed 2.

Therefore, in the present disclosure, by operating the ejection unit 30, the magnet blocks 21 can be easily detached from the machine bed 2 or magnetically attached to the machine bed 2 again, the position of the fixed seat 10 can be easily adjusted to meet operation requirements at any time.

It is worth mentioning that although the ejection unit 30 is exemplified in this embodiment to include the threaded rod 31, the operating member 32, the supporting member 33, and the spring 34, it is not limited to the above structure. For example, in other embodiments, the ejection unit 30 may include a cam structure operable to achieve the goal that the supporting member 33 can move between the first and second positions.

In addition, to prevent situations that the user's fingers can be clamped between the fixed seat 10 and the machine bed 2 from sudden movement caused by the magnetic attraction of the magnet blocks 21 and the machine bed 2, two ejection units 30 (not shown) may be installed, and in the beginning of the mounting operation the supporting member 33 of each of the ejection units 30 may be set to the second position so it protrudes out of the bottom surface 11, so that there is a gap between the bottom surface 11 of the fixed seat 10 and the machine bed 2 before the fixation device 100 is fully mounted on the machine bed 2. After the mounting position of the fixation device 100 is determined, the magnet blocks 21 are magnetically attached and fixed on the machine bed 2 by releasing the threaded rods 31.

Furthermore, besides the triangular shape of the above-described embodiment, when the number of magnet blocks 21 is adjusted to 4, the contour shape of the fixed seat 10 may be changed to be more quadrilateral and has four corner portions for installation of four magnet blocks 21, and the at least one ejection unit 30 may be mounted between two of the magnet blocks 21, achieving the same purpose and effect as the above-described embodiment.

In summary, the fixation device 100 according to this disclosure has a simple overall structure and easy operation. It is very convenient to detach from and reinstall on the machine bed 2. As such, to adjust the position of the machine tool 1 after installation is also rather easy and convenient, the object of this disclosure can indeed be achieved.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is(are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A fixation device adapted to be mounted with a machine tool and mounted to a machine bed that is made of a magnetic metal material, said fixation device comprising:
a fixed seat having a bottom surface and a plurality of grooves that are formed in said bottom surface;
a magnetic unit including a plurality of magnet blocks that are fixed respectively in said grooves and that are adapted to be magnetically positioned on the machine bed; and
at least one ejection unit mounted on said fixed seat and including an operating member and a supporting member that is located under said operating member, said operating member being operable to move said supporting member from a first position, where a bottom end of said supporting member is flush with said bottom surface of said fixed seat, to a second position, where said bottom end of said supporting member protrudes out from said bottom surface of said fixed seat.

2. The fixation device as claimed in claim 1, wherein said fixed seat further has a top surface opposite to said bottom surface, a bearing groove formed in said bottom surface for receiving said supporting member when said operating member is at the first position, and a threaded hole extending from said top surface to said bearing groove, said ejection unit further including a threaded rod engaging threadedly said threaded hole, said operating member being connected to a top end of said threaded rod, said supporting member being connected to a bottom end of said threaded rod, said operating member being operable to drive rotation of said threaded rod and move said fixed seat upward or downward relative to said threaded rod.

3. The fixation device as claimed in claim 2, wherein said ejection unit further includes a spring sleeved on said threaded rod and having opposite ends that abut respectively against said operating member and said top surface of said fixed seat for biasing said operating member away from said fixed seat.

4. The fixation device as claimed in claim 1, wherein said fixed seat further has a top surface opposite to said bottom surface, and a plurality of fastening holes formed in said top surface and extending respectively to said grooves, each magnet block of said magnetic unit having an attraction surface, an upper end surface that is opposite to said attraction surface, and a mounting hole that extends from said attraction surface to said upper end surface and that is stepped, said magnetic unit further including a plurality of fastening member that extend respectively through said mounting holes of said magnet blocks and respectively through said fastening holes.

5. The fixation device as claimed in claim 1, wherein said fixed seat further has a top surface opposite to said bottom surface, and a handle mounted on said top surface.

6. The fixation device as claimed in claim 1, wherein said fixed seat is triangular, and further has three sides and three corner portions arranged alternately, the number of said grooves being three, each of said grooves being located at an inner side of a respective one of said corner portions, said ejection unit being mounted between one of said grooves and the respective one of said corner portions.

7. The fixation device as claimed in claim 6, wherein said fixed seat further has a top surface opposite to said bottom surface, and a protrusion protruding from said top surface, said protrusion being aligned with two of said grooves, and located at an inner side of one of said sides that is disposed between said two of said grooves, said protrusion being adapted to be mounted with a stand of the machine tool thereon.
